(19) United States
(12) Patent Application Publication
(10) Pub. No.: US 2013/0089136 A1
(43) Pub. Date: Apr. 11, 2013

(54) Spatial Intra Prediction Estimation Based on Mode Suppression in Macroblocks of a Video Frame

(71) Applicants: Ranga Ramanujam Srinivasan, Villupuram (IN); Mangesh Devidas Sadafale, Nagpur (IN)

(72) Inventors: Ranga Ramanujam Srinivasan, Villupuram (IN); Mangesh Devidas Sadafale, Nagpur (IN)

(73) Assignee: TEXAS INSTRUMENTS INCORPORATED, Dallas, TX (US)

(21) Appl. No.: 13/270,069

(22) Filed: Oct. 10, 2011

(51) Int. Cl. H04N 7/34; H04N 7/50

(52) U.S. Cl. 375/240.03; 375/240.16; 375/E07.116; 375/E07.139

(57) ABSTRACT

A method includes determining whether spatial intra prediction of pixels of a macroblock of a video frame is to be performed at a macroblock level or a sub-macroblock level. The method also includes suppressing a horizontal mode or a vertical mode of spatial intra prediction of pixels of the macroblock at the macroblock level or the sub-macroblock level based on the determination when spatial intra prediction of pixels of the immediate previous macroblock is at the sub-macroblock level. When the spatial intra prediction of the pixels of the macroblock is at the macroblock level, the horizontal mode or the vertical mode is suppressed for the entire macroblock. When the spatial intra prediction of the pixels of the macroblock is at the sub-macroblock level, the horizontal mode or the vertical mode is suppressed for a corresponding first row or a first column of blocks of pixels of the macroblock.

### FIELD OF TECHNOLOGY

Embodiments of the disclosure relate to spatial intra prediction estimation of video frames.

### BACKGROUND

Spatial intra prediction of a macroblock of a video frame in a video encoder utilizes reconstructed pixels of one or more immediate previous macroblocks to generate a prediction macroblock. The spatial location of the immediate previous macroblocks depends on the mode of intra prediction. Due to complexity involved in the encoding process, (e.g., processing through the entire pipeline of the video encoder), the reconstructed pixels of an immediate previous macroblock could be unavailable at the time of intra prediction estimation of the macroblock. The original previous macroblock is then utilized instead of the reconstructed previous macroblock to generate the prediction macroblock. The error associated with the prediction is transformed, quantized and coded as a compressed bit stream.

During decoding, the quantized error coefficients are re-scaled and inverse transformed to generate a difference block. The prediction block during decoding is generated based on the header information decoded from the compressed bit stream. While original pixels of the immediate previous macroblock need to be utilized during intra prediction estimation through the video encoder, the prediction block is generated during decoding based on the reconstructed immediate previous block. Due to the difference therebetween, lines of noise are visible following the decoding of the video frame and the rendering thereof along the direction of the intra prediction mode.

### SUMMARY

In one embodiment, a method includes determining whether spatial intra prediction of pixels of a macroblock of a video frame is to be performed at a macroblock level or a sub-macroblock level based on a variation in intensity of pixels between the macroblock and an immediate previous macroblock along a direction of a horizontal mode or a vertical mode of spatial intra prediction thereof. The macroblock is configured to be an array of pixels, the horizontal mode of spatial intra prediction is configured to be along a direction of a row of the array of pixels at the macroblock level and the sub-macroblock level, and the vertical mode of spatial intra prediction is configured to be along a direction of a column of the array of pixels at the macroblock level and the sub-macroblock level.

The method also includes suppressing, when spatial intra prediction of pixels of the immediate previous macroblock is at the sub-macroblock level, the horizontal mode or the vertical mode of spatial intra prediction of pixels of the macroblock at the macroblock level or the sub-macroblock level based on the determination. When the spatial intra prediction of the pixels of the macroblock is at the macroblock level, the horizontal mode or the vertical mode is suppressed for the entire macroblock. When the spatial intra prediction of the pixels of the macroblock is at the sub-macroblock level, the horizontal mode or the vertical mode is suppressed for a corresponding first column or a first row of blocks of pixels of the macroblock. The macroblock is configured to include an array of blocks of pixels at the sub-macroblock level.

In another embodiment, a video encoder includes an intra prediction estimation module configured to receive a video frame and to determine whether spatial intra prediction of pixels of a macroblock of the video frame is to be performed at a macroblock level or a sub-macroblock level based on a variation in intensity of pixels between the macroblock and an immediate previous macroblock along a direction of a horizontal mode or a vertical mode of spatial intra prediction thereof. The macroblock is configured to be an array of pixels, the horizontal mode of spatial intra prediction is configured to be along a direction of a row of the array of pixels at the macroblock level and the sub-macroblock level, and the vertical mode of spatial intra prediction is configured to be along a direction of a column of the array of pixels at the macroblock level and the sub-macroblock level.

Also, the intra prediction estimation module is configured to suppress the horizontal mode or the vertical mode of spatial intra prediction of pixels of the macroblock at the macroblock level or the sub-macroblock level based on the determination when spatial intra prediction of pixels of the immediate previous macroblock is at the sub-macroblock level. When the spatial intra prediction of the pixels of the macroblock is at the macroblock level, the horizontal mode or the vertical mode is suppressed for the entire macroblock. When the spatial intra prediction of the pixels of the macroblock is at the sub-macroblock level, the horizontal mode or the vertical mode is suppressed for a corresponding first column or a first row of blocks of pixels of the macroblock. The macroblock is configured to include an array of blocks of pixels at the sub-macroblock level. Further, the intra prediction estimation module is configured to perform spatial intra prediction of the pixels of the macroblock of the video frame based on the determination and the suppression, and to output a prediction macroblock.

Also, the video encoder includes a subtractor module configured to receive the prediction macroblock from the intra prediction estimation module and the macroblock of the video frame and to output the difference therebetween as a residual macroblock, a transform and quantization module configured to transform the residual macroblock to a different domain and to quantize the output of the transformation, and a coding module configured to code the output of the transform and quantization module.

In another embodiment, a video processing system includes a video encoder configured to encode a video frame input thereto. The video encoder includes an intra prediction estimation module configured to determine whether spatial intra prediction of pixels of a macroblock of the video frame is to be performed at a macroblock level or a sub-macroblock level based on a variation in intensity of pixels between the macroblock and an immediate previous macroblock along a direction of a horizontal mode or a vertical mode of spatial intra prediction thereof. The macroblock is configured to be an array of pixels, the horizontal mode of spatial intra prediction is configured to be along a direction of a row of the array of pixels at the macroblock level and the sub-macroblock level, and the vertical mode of spatial intra prediction is configured to be along a direction of a column of the array of pixels at the macroblock level and the sub-macroblock level. The intra prediction estimation module is also configured to suppress the horizontal mode or the vertical mode of spatial intra prediction of pixels of the macroblock at the macroblock level or the sub-macroblock level based on the determination when spatial intra prediction of pixels of the immediate previous macroblock is at the sub-macroblock level.

When the spatial intra prediction of the pixels of the macroblock is at the macroblock level, the horizontal mode or the vertical mode is suppressed for the entire macroblock. When the spatial intra prediction of the pixels of the macroblock is at the sub-macroblock level, the horizontal mode or the vertical mode is suppressed for a corresponding first column or a first row of blocks of pixels of the macroblock. The macroblock is configured to include an array of blocks of pixels at the sub-macroblock level. Further, the intra prediction estimation module is configured to perform spatial intra prediction of the pixels of the macroblock of the video frame based on the determination and the suppression, and to output a prediction macroblock.

The video encoder also includes a subtractor module configured to receive the prediction macroblock from the intra prediction estimation module and the macroblock of the video frame and to output the difference therebetween as a residual macroblock, a transform and quantization module configured to transform the residual macroblock to a different domain and to quantize the output of the transformation, and a coding module configured to code the output of the transform and quantization module in a compressed bit stream. The video processing system also includes a video decoder configured to receive the compressed bit stream from the video encoder and to decode the macroblock of the video frame.

The methods and systems disclosed herein may be implemented in any means for achieving various aspects, and may be executed in a form of a machine-readable medium embodying a set of instructions that, when executed by a machine, causes the machine to perform any of the operations disclosed herein.

Other features will be apparent from the accompanying drawings and from the detailed description that follows.

### BRIEF DESCRIPTION OF THE VIEWS OF DRAWINGS

Example embodiments are illustrated by way of example and not limitation in the figures of the accompanying drawings, in which like references indicate similar elements and in which:

FIG. 1 is a schematic view of a video encoder, according to one or more embodiments;

FIG. 2 is a schematic view of intra prediction of a macroblock of an input video frame from spatially neighboring macroblocks thereof, according to one or more embodiments;

FIG. 3 is a schematic view of intra prediction of a macroblock at the 16×16 macroblock level, according to one or more embodiments;

FIG. 4 is a schematic view of intra prediction of a macroblock at the 8×8 pixel block level, according to one or more embodiments;

FIG. 5 is a schematic view of intra prediction of a macroblock at the 4×4 pixel block level, according to one or more embodiments;

FIG. 6 is a flowchart detailing the operations involved in intra prediction at the macroblock and the sub-macroblock level, according to one or more embodiments; and

FIG. 7 is a process flow diagram detailing the operations involved in a method of improved spatial intra prediction, according to one or more embodiments.

Other features of the present embodiments will be apparent from the accompanying drawings and from the detailed description that follows.

### DETAILED DESCRIPTION

Disclosed are a method, an apparatus and/or a system of improving spatial intra prediction through mode suppression in macroblocks of a video frame. Although the present embodiments have been described with reference to specific example embodiments, it will be evident that various modifications and changes may be made to these embodiments without departing from the broader spirit and scope of the various embodiments.

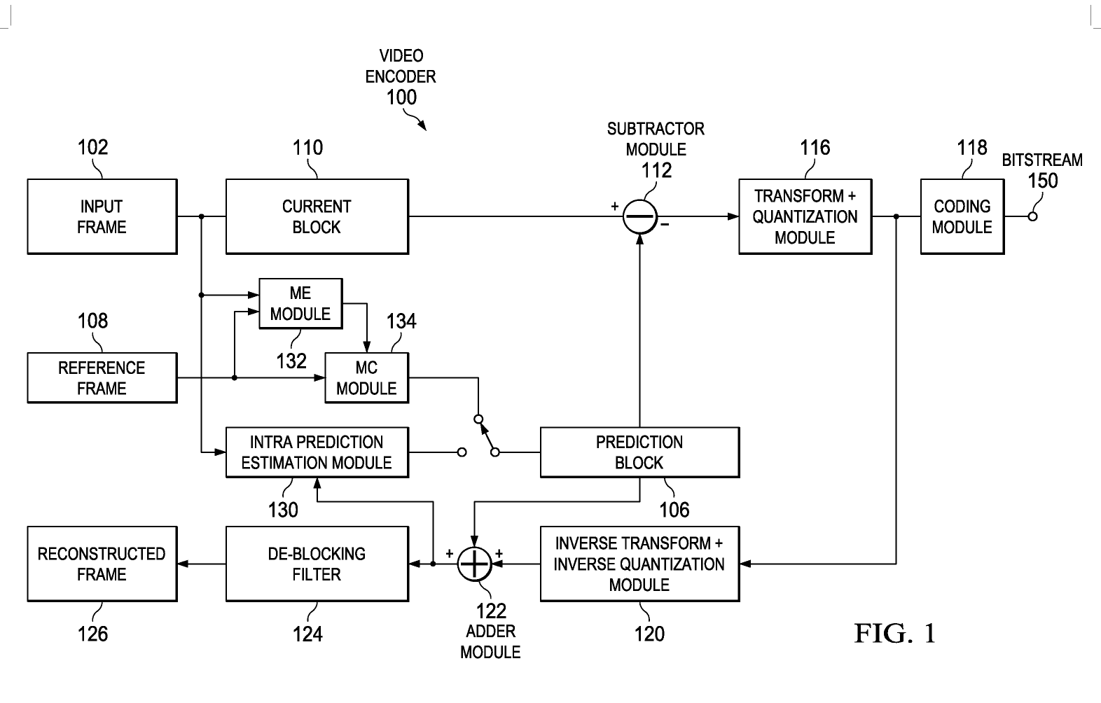

FIG. 1 illustrates a video encoder 100, according to an embodiment of the invention. Macroblocks of a video frame (e.g., input frame 102) are encoded in an intra or inter mode of prediction based on the type thereof. An Intra (I-) frame/slice includes I-macroblocks, a Predictive (P-) frame/slice includes both I-macroblocks and P-macroblocks, and a Bi-predictive (B-) frame/slice includes both I-macroblocks and B-macroblocks. Other frame/slice types are omitted for the sake of aiding descriptive brevity. An I-macroblock is predicted through intra prediction from constituent samples in the same frame, a P-macroblock is predicted through inter prediction from one or more reference frame(s) (e.g., an I-frame and/or a P-frame) in a temporal past relative to the frame including the P-macroblock, and a B-macroblock is predicted through inter prediction from one or more reference frame(s) (e.g., an I-frame and/or a P-frame) both in the temporal past and a temporal future relative to the frame including the B-macroblock.

For each block of a macroblock of input frame 102, a prediction block 106 is formed. In the intra mode, prediction block 106 is formed from samples in input frame 102 that have been previously encoded, decoded and reconstructed. In the inter mode, prediction block 106 is formed through motion-compensation (MC; e.g., through MC module 134)/motion-estimation (ME; e.g., through MC module 132) based on or more reference frame(s) (e.g., reference frame 108). The prediction reference for each macroblock of input frame 102 in the inter mode is one or more reference frame(s) (e.g., reference frame 108) in a temporal past and/or a temporal future relative to input frame 102. Prediction block 106 is subtracted (e.g., through subtractor module 112) from current block 110 associated with input frame 102 to produce a residual block 114 that is transformed and quantized (e.g., through transform+quantization module 116) to generate a set of quantized transform coefficients. Although FIG. 1 illustrates the transformation and the quantization in the same module (e.g., transform+quantization module 116), the aforementioned processes may also be shown as occurring in separate modules. The set of quantized transform coefficients is reordered and entropy coded (e.g., coding module 118). Coding module 118 is configured to perform lossless encoding (e.g., through Huffman coding) of the input stream thereof. In one or more embodiments, the entropy encoded coefficients, along with information required to decode each macroblock (e.g., prediction modes, quantization parameters), is in the form of a compressed bit stream (e.g., bit stream 150) that is configured to be transmitted/stored.

Video encoder 100 is also configured to reconstruct blocks in a macroblock of input frame 102 to serve as a reference for intra prediction (e.g., trough intra prediction estimation module 130). The quantized transform coefficients are inverse transformed and inverse quantized (e.g., through inverse transform+inverse quantization module 120) to generate a difference block (not shown). The inverse transform and inverse quantization processes also occurs in separate modules. Difference block is added (e.g., through adder module 122) to prediction block 106 to generate a reconstructed block (not shown). A de-blocking filter 124 is applied to the reconstructed block to reduce the effects of distortion due to blocking and reconstructed frame 126 may be generated from the series of blocks.

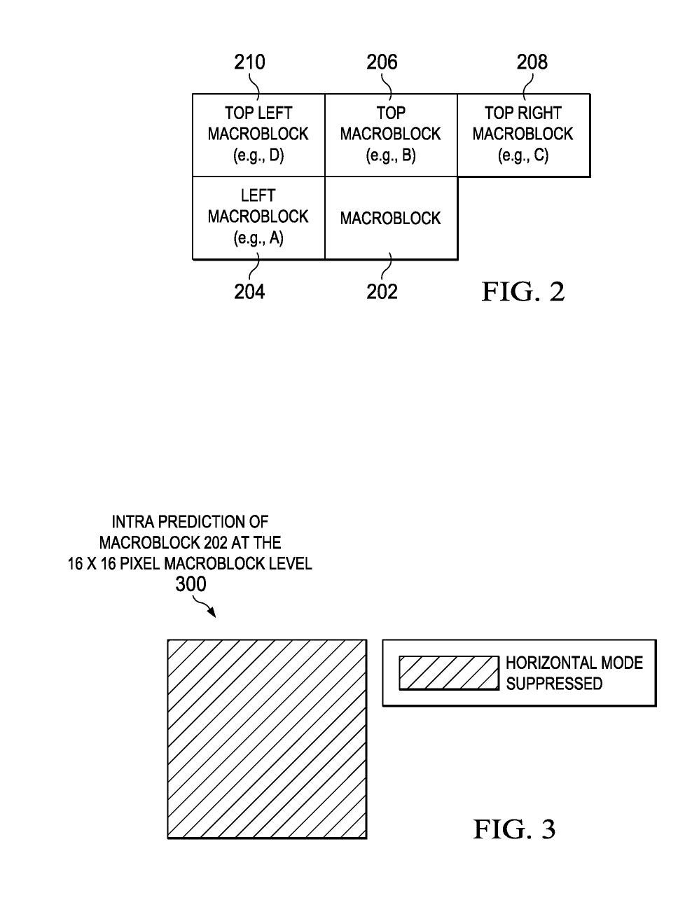

Assuming an H.264 video standard, each macroblock of a video frame may be 16×16 pixels in dimension. Each macroblock of input frame 102 is predicted using temporal (inter-) and spatial (intra-) redundancy in video frame sequences. During intra prediction, a macroblock in input frame 102 is predicted from spatially neighboring macroblocks. The processes associated with spatial intra prediction of macroblocks of input frame 102 are performed by intra prediction estimation module 130. FIG. 2 illustrates intra prediction of a macroblock 202 in input frame 102 from spatially neighboring macroblocks thereof, according to one or more embodiments. Macroblock 202 is predicted from the left macroblock (e.g., A 204), the top macroblock (e.g., B 206), the top right macroblock (e.g., C 208) and/or the top left macroblock (e.g., D 210). Intra prediction of macroblocks includes three block sizes, viz., 16×16 pixels, 8×8 pixels and 4×4 pixels. The 16×16 pixel block prediction is employed in predicting macroblocks in a spatial region having little variation of pixel intensity between macroblocks. The 4×4 pixel block prediction and/or the 8×8 block pixel prediction is utilized in predicting spatially complicated portions of input frame 102, e.g., portions where there is a lot of variation in pixel intensity. In an embodiment, the 4×4 pixel block prediction and the 8×8 pixel block prediction occurs at a sub-macroblock level.

Four modes are available to predict the entire 16×16 pixel luma (luminance) component of macroblock 202 instead of blocks thereof. For example, the current macroblock (e.g., macroblock 202) of input frame 102 is predicted from 16 pixels of the top macroblock (e.g., B 206), 1 pixel of the top left macroblock (e.g., D 210) and/or 16 pixels of the left macroblock (e.g., A 204) through one of four prediction modes. The four modes of prediction include mode 0 (vertical, or, extrapolation from top samples), mode 1 (horizontal, or, extrapolation from left samples), mode 2 (DC, or, mean of top samples and left samples) and mode 3 (plane; here, a linear “plane” function is fitted to the top samples and the left samples). Mode 3 works well in areas of input frame 102 that have smoothly-varying luminance. One skilled in the art will be aware of the four modes of 16×16 pixel luma prediction. Therefore, figures associated therewith have been omitted for the sake of convenience.

For each prediction mode (e.g., mode 0, mode 1, mode 2, mode 3), the residual macroblock (e.g., residual block 114 at the macroblock level) is obtained from the difference between the current macroblock (e.g., macroblock 202) and prediction macroblock (e.g., prediction block 106). The mode having the lowest residual associated with the residual macroblock is selected as the best prediction mode. In one or more embodiments, 4×4 pixel block prediction and 8×8 pixel block prediction have nine prediction modes (e.g., mode 0 (vertical), mode 1 (horizontal), mode 2 (DC), mode 3 (diagonal down-left), mode 4 (diagonal down-right), mode 5 (vertical-right), mode 6 (horizontal-down), mode 7 (vertical-left), mode 8 (horizontal-up)) associated therewith. Again, the aforementioned modes are known to one skilled in the art. Therefore, figures associated therewith have been omitted for the sake of convenience. Again, the mode with the lowest residual (e.g., residual at the block level, or, residual block 114) is chosen as the best prediction mode.

During spatial intra prediction, video encoder 100 is configured to predict macroblock 202 based on the left macroblock (e.g., A 204), the top macroblock (e.g., B 206), the top right macroblock (e.g., C 208) and/or the top left macroblock (e.g., D 210). Therefore, reconstruction of the aforementioned left macroblock (e.g., A 204), the top macroblock (e.g., B 206), the top right macroblock (e.g., C 208) and/or the top left macroblock (e.g., D 210) may need to be completed prior to the prediction of macroblock 202. In other words, processing through the complete pipeline of video encoder 100, i.e., forward processing (e.g., through transform+quantization module 116), inverse processing (e.g., through inverse transform+inverse quantization module 120) and addition (e.g., through adder 122), needs to be complete for the reference macroblocks (viz., A 204, B 206, C 208 and D 210) prior to prediction of macroblock 202. Assuming selection of the horizontal mode (or, mode 1) for intra prediction, it is difficult for video encoder 100 to have the left macroblock (e.g., A 204) available at the time of prediction of macroblock 202. Different modes of intra prediction render different blocks unavailable during the time of prediction of macroblock 202.

When there is no possibility of prediction of macroblock 202 using the left macroblock (e.g., A 204) due to the unavailability thereof, the original macroblock corresponding to the same position of the reconstructed left macroblock is utilized for intra prediction. Assuming a video source (e.g., a digital camera, a camcorder) including an encoding engine therein, the original macroblock corresponds to the unprocessed output thereof and the reconstructed macroblock corresponds to the input to the display unit. The input to the display unit is provided following decoding of the encoded video, or, during playback of the video on the display unit of the video source. The video, for example, is stored in a memory associated with the video source. Thus, instead of utilizing a macroblock of the input to the display unit during prediction of macroblock 202, a corresponding macroblock of the direct, high-quality, and unprocessed output of the video source is utilized. The difference between the original macroblock used during prediction and the reconstructed macroblock that theoretically should have been used during prediction is propagated as noise. The noise is visible upon playback of the video/frame after the encoding thereof and the rendering thereof on the display unit. The display unit is associated with the video source or is distinct from the video source.

In the example scenario of utilizing the original macroblock corresponding to the left macroblock (e.g., A 204) for prediction instead of the reconstructed macroblock, the noise is visible as a horizontal noise (e.g., from left to right). Thus, depending on the mode of prediction, the noise is visible as lines propagating along the direction of prediction. The left macroblock (e.g., A 204) is discussed with reference to mode 1 because pixels of macroblock 202 are predicted using pixels of the left macroblock (e.g., A 204). Depending on the choice of prediction modes, pixels of other macroblocks (e.g., the top macroblock, or, B 206 in the case of mode 0, the top left macroblock, or, D 210 in the case of mode 4, the top right macroblock, or, C 208 in the case of mode 3) is utilized to predict pixels of macroblock 202.

The aforementioned horizontal noise propagation is a problem in I-frames including I-macroblocks. It is noted that there are a sequence of frames including one I-frame every twenty frames. The P- and B-frames therein refer to the aforementioned I-frame. Further, each macroblock in a P-frame or a B-frame is encoded as an I-macroblock, a P-macroblock or a B-macroblock. The encoding of the I-macroblock in a P-/B-frame is similar to that in an I-frame. Thus, the horizontal noise propagation problems also occurs in P-/B-frames referring to an I-frame or a P-/B-frame including I-macroblock(s).

The difference between current block 110 and prediction block 106, or, residual block 114 is subjected to transformation and quantization (e.g., through transform+quantization module 116), encoded and transmitted in bit stream 150, as discussed above. During quantization, the dynamic range of the encoded information (e.g., represented as a number of bits) may be reduced. For example, a 10 bit length associated with image information is reduced to 4 bits, thereby reducing precision. During decoding, the image information is again made to 10 bits. Decoding involves receiving the compressed bit stream (e.g., bit stream 150) and entropy decoding the data to generate a set of quantized coefficients. The aforementioned quantized coefficients are re-scaled and inverse transformed to generate a block analogous to the difference block in video encoder 100. A prediction block (analogous to prediction block 106) is generated based on the header information decoded from bit stream 150. The prediction block is added to the difference block and filtered to create the reconstructed block. While pixels of the original block of the immediate left macroblock (e.g., A 204) needs to be utilized instead of pixels of the reconstructed block during prediction associated with video encoder 100 due to the possible unavailability thereof, the decoder generates the prediction block based on the reconstructed block associated with the immediate left macroblock (e.g., A 204). Due to the difference between the pixels of the original macroblock used in prediction associated with video encoder 100 and the reconstructed macroblock used during decoding, the horizontal noise is visible following the decoding of the video and the rendering thereof.

Intra prediction in the H.264 standard includes three block sizes, viz., 16×16 pixels, 8×8 pixels and 4×4 pixels, as discussed above. As discussed above, intra prediction is performed at the 16×16 pixel (or, a complete macroblock) level in regions of input frame 102 having little variations in pixel intensity therein. Intra prediction is performed at the 8×8 pixel (sub-macroblock) level and 4×4 pixel (sub-macroblock) level in regions of input frame 102 having lots of variations in pixel intensity therein. Thus, the block sizes selected during intra prediction is directly or indirectly representative of activity in the region including macroblock 202. 4×4 pixel block level prediction indicates a higher level of activity (e.g., variations of pixel intensity in region) than an 8×8 pixel block level prediction, which, in turn, indicates a higher level of activity than a 16×16 pixel macroblock level prediction.

Analogous to prediction at the macroblock (e.g., 16×16 pixel block) level, prediction using the horizontal mode at the 4×4 pixel block level and the 8×8 pixel block level involves utilizing the preceding block. A 16×16 pixel macroblock is thought of as including four 8×8 pixel blocks and sixteen 4×4 pixel blocks. Thus, there are two 8×8 pixel blocks in each row and column of a 16×16 pixel macroblock. Likewise, there are four 4×4 pixel blocks in each row and column of a 16×16 pixel macroblock. Thus, a 16×16 pixel macroblock includes two rows of two 8×8 pixel blocks each or two columns of two 8×8 pixel blocks each. Similarly, a 16×16 pixel macroblock includes four rows of four 4×4 pixel blocks each or four columns of four 4×4 pixel blocks each. In the horizontal mode, pixels of current block 110 are predicted using pixel(s) of the immediate preceding left block (e.g., A 204). Moreover, the preceding left block/pixel(s) may/may not be part of the same macroblock. For example, pixels of the first 4×4/8×8 pixel block of macroblock 202 are predicted row-wise using pixel(s) of a corresponding block of the left macroblock (e.g., A 204). Pixels of the second 4×4/8×8 pixel block of macroblock 202 in the first row may be predicted row-wise using pixel(s) of the first 4×4/8×8 pixel block of macroblock 202. Once a row is finished (e.g., with the second 8×8 pixel block, with the fourth 4×4 pixel block), prediction of the second row of macroblock 202 commences. Here, again, pixels of the first 4×4/8×8 pixel block are predicted row-wise using pixel(s) of a corresponding block of the left macroblock. Similarly, prediction for all blocks (e.g., 4×4/8×8 pixel blocks) of macroblock 202 is completed utilizing the horizontal mode therefor.

For example, current block 110 is a 4×4 pixel block or an 8×8 pixel block of macroblock 202. Analogous to the horizontal mode of prediction at the 16×16 pixel macroblock level, the horizontal mode of prediction at the 8×8 pixel block level and the 4×4 pixel block level requires the immediate left block/pixel(s) of current block 110 to be reconstructed prior to the prediction thereof. However, the processing required of the immediate left block/pixel(s) (e.g., processing through the complete pipeline of video encoder 100) is not completed prior to the prediction (or, at the time of prediction). Therefore, the original block/pixel(s) of the immediate left macroblock (e.g., A 204) is utilized instead of the reconstructed block, which leads to the horizontal noise being propagated along the direction of prediction.

At the 16×16 macroblock level, the 8×8 block level and the 4×4 block level, the choice of intra prediction mode is signaled to the decoder. The aforementioned information is encoded in bit stream 150 configured to be received by the decoder. Correlation between modes for neighboring macroblocks or neighboring blocks of current block 110 of macroblock 202 is utilized in the intra prediction of the corresponding macroblock 202 (e.g., 16×16 pixels) or blocks (e.g., 4×4 pixels, 8×8 pixels) therein. For example, if the horizontal mode (e.g., mode 1) was utilized in the prediction associated with previous blocks of current block 110/previous macroblocks of macroblock 202, then the horizontal mode is chosen as the probable mode for current block 110 of macroblock 202/macroblock 202. In another example, if two of the previous blocks of current block 110 within macroblock 202 are encoded using different modes, then the probable mode for current block 110 of macroblock 202 is chosen to be one of the two different modes for the previous blocks with the smaller prediction error. Else, the probable mode for current block 110 of macroblock 202 is chosen to be, for example, the DC mode.

Video encoder 100 is configured to transmit flag data for prediction at each of the 16×16 pixel block level, 8×8 pixel block level and 4×4 pixel block level. Depending on the value of the flag data, the probable mode is used or changed to a mode having the least prediction error among the remaining modes. In the aforementioned procedure, if prediction for the previous blocks of current macroblock 202 was at the 8×8 pixel level or the 4×4 pixel level and was performed using the horizontal mode (e.g., mode 1), then the horizontal mode is also utilized in the prediction of current block 110. The previous blocks is also a part of the left macroblock (e.g., A 204). If the previous macroblocks at the 16×16 pixel level were predicted using the horizontal mode (e.g., mode 1), then current macroblock (e.g., macroblock 202) is also predicted using the horizontal mode. However, as already seen above, the use of the original previous macroblock/block (e.g., left macroblock A 204, blocks of the left macroblock A 204, and blocks of macroblock 202) during prediction instead of the reconstructed macroblock/block due to the unavailability thereof leads to horizontal noise propagation.

In order to mitigate horizontal noise propagation, the horizontal mode is suppressed during prediction of the current macroblock (e.g., macroblock 202)/the current block (e.g., current block 110) of the current macroblock (e.g., macroblock 202) and another appropriate mode is utilized. While the horizontal noise propagation is suppressed, increased prediction error may/may not result from the utilization of another mode. At a sub-macroblock level, it is not prudent to suppress horizontal modes for all blocks. An intelligent mechanism of determining where to suppress horizontal modes and where not to suppress horizontal modes serves the dual purpose of preventing propagation of horizontal noise and increasing efficiency of prediction, as will be discussed below.

For example, when the vertical mode is employed for the current block (e.g., current block 110) of current macroblock (e.g., macroblock 202) for prediction despite the previous blocks (e.g., the block left of current block 110) being predicted using the horizontal mode, the horizontal noise associated with the block to the immediate left of the current block (e.g., current block 110) does not propagate thereto because the block to the top of the current block (e.g., current block 110) may be utilized in the vertical mode of prediction. At the 16×16 pixel macroblock level, when the vertical mode is employed for prediction of macroblock 202 despite the left macroblock (e.g., A 204) being predicted through the horizontal mode, the top macroblock (e.g., B 206) is utilized. It is obvious that the block to the top of the current block (e.g., current block 110) and the top macroblock (e.g., B 206) is more likely be reconstructed prior to prediction of the current block (e.g., current block 110) and the current macroblock (e.g., macroblock 202) respectively because of the horizontal mode utilized for the prediction thereof. In the horizontal mode, the top block/top macroblock (e.g., B 206) is reconstructed ahead of the left block/left macroblock (e.g., A 204).

The utilization of the horizontal mode for the current block (e.g., current block 110)/current macroblock (e.g., macroblock 202) involves utilizing the original immediate left block/left macroblock (e.g., A 204) for the prediction, which contributes to the horizontal noise propagation thereto. As the block to the top of the current block/top macroblock (e.g., B 206), for example, is reconstructed well in advance of the immediate left block/left macroblock (e.g., A 204) due to the horizontal mode being utilized for the prediction thereof, the reconstructed block/reconstructed macroblock associated with the top block/top macroblock (e.g., B 206) is available for the vertical mode of prediction. The utilization of the reconstructed block/reconstructed macroblock during the vertical mode of prediction of the current block (e.g., current block 110) of the current macroblock (e.g., macroblock 202)/the current macroblock (e.g., macroblock 202) leads to suppression of the horizontal noise propagation. Even if a DC mode, for example, is used for prediction, the averaging of the vertical mode and the horizontal mode may lead to at least some of the reconstructed block/reconstructed macroblock at the top being used. The horizontal noise propagation, therefore, is suppressed in any other mode utilized for the prediction of the current block (e.g., current block 110) of the current macroblock (e.g., macroblock 202).

Suppressing horizontal modes for all blocks of the current macroblock (e.g., macroblock 202) at the 4×4 pixel block level and the 8×8 pixel block level leads to increased prediction error. Therefore, horizontal modes for only certain blocks at the sub-macroblock level needs to be suppressed. Discussion associated with the horizontal mode suppression is conducted with reference to examples at the macroblock (e.g., macroblock 202) level and the sub-macroblock (e.g., 4×4 pixel block, 8×8 pixel block; or, current block 110 of macroblock 202) level. FIG. 3 illustrates intra prediction of macroblock 202 at the 16×16 pixel macroblock level 300, according to one or more embodiments. Here the prediction block level (e.g., 4×4 pixel block level, 8×8 pixel block level) for the left macroblock (e.g., A 204) is checked for prior to making a decision with regard to the mode of prediction for macroblock 202. When the intra prediction associated with blocks of the left macroblock (e.g., A 204) are at the 4×4 pixel block level or the 8×8 pixel block level, variations in intensity of pixels in the region including the blocks is high.

When there is a lower contrast/variation in intensity of pixels around a region including the current macroblock (e.g., macroblock 202), the intra prediction is performed at the 16×16 pixel macroblock level. However, when there is a transition from a region of higher contrast to a region of lower contrast from the left macroblock (e.g., A 204) to the current macroblock (e.g., macroblock 202) and when the horizontal mode is utilized for intra prediction associated with blocks of the left macroblock (e.g., A 204), the horizontal mode is suppressed for the entire current macroblock (e.g., macroblock 202) to mitigate the noise propagation. FIG. 3 illustrates that the horizontal mode is suppressed in macroblock 202. Any of the other available modes (e.g., mode 1 or, vertical mode) are utilized for prediction of the current macroblock (e.g., macroblock 202) at the 16×16 pixel macroblock level. As discussed above, the utilization of other modes leads to blocks of a reconstructed macroblock (e.g., reconstructed macroblock associated with top macroblock B 206) being used to predict the current macroblock (e.g., macroblock 202) instead of an original macroblock of the left macroblock (e.g., A 204) being utilized during the horizontal mode due to the unavailability of the corresponding reconstructed macroblock.

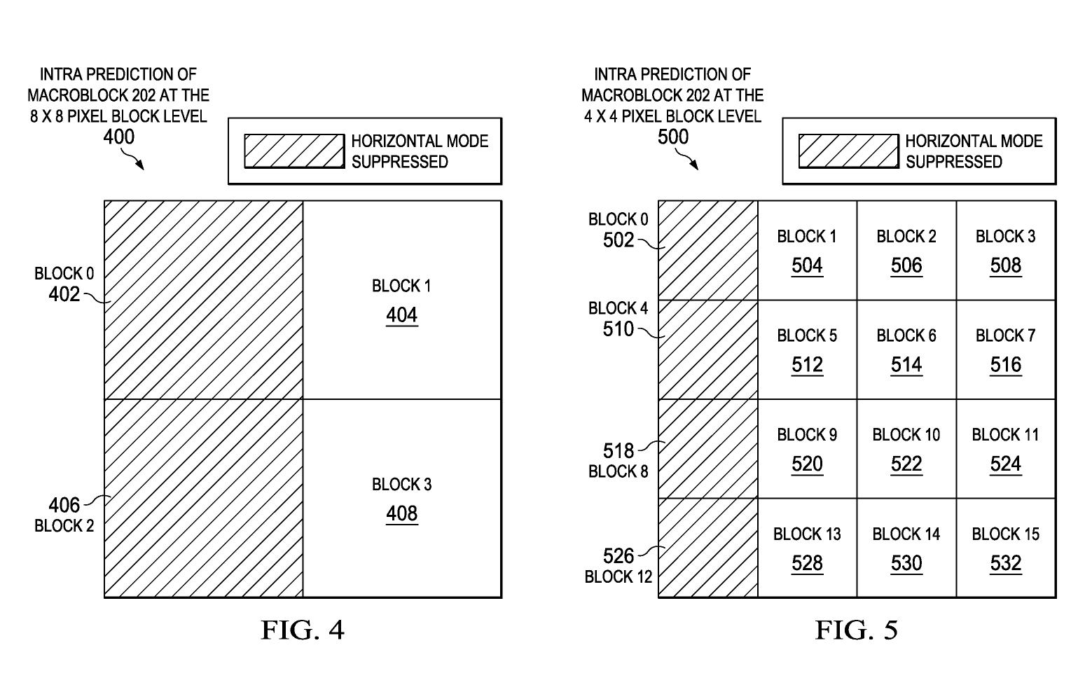

FIG. 4 illustrates intra prediction of the current macroblock (e.g., macroblock 202) at the 8×8 pixel block level 400, according to one or more embodiments. The prediction block level (e.g., 4×4 pixel block level, 8×8 pixel block level) for the left macroblock (e.g., A 204) is checked for prior to making a decision with regard to the mode of prediction for blocks of the current macroblock (e.g., macroblock 202). When the intra prediction associated with the left macroblock is at the 4×4 pixel block level or the 8×8 pixel block level and the variation in the intensity of pixels in the region including current macroblock (e.g., macroblock 202) continues, the intra prediction for the current macroblock (e.g., macroblock 202) is performed at the 8×8 pixel block level or the 4×4 pixel block level. As shown in FIG. 4, when the horizontal mode is used for intra prediction associated with blocks of the left macroblock (e.g., A 204), intra prediction at the 8×8 pixel block level for the current macroblock (e.g., macroblock 202) involves suppressing the horizontal mode in each of block 0 402 and block 2 406. Any mode other than the horizontal mode is utilized to predict block 0 402 and block 2 406 due to the possibility of utilizing reconstructed blocks therein.

The current macroblock (e.g., macroblock 202) includes four 8×8 pixel blocks, viz., block 0 402, block 1 404, block 2 406 and block 3 408. Assuming the horizontal mode being used to predict blocks of the left macroblock (e.g., A 204), prediction of the 8×8 pixel blocks is done with block 0 402. As the availability of pixels of a corresponding reconstructed block of the immediately preceding left macroblock (e.g., A 204) is made difficult, the use of an original block of the left macroblock (e.g., A 204) instead of the reconstructed block results in propagation of horizontal noise in block 0 402. Therefore, the horizontal mode is suppressed for block 0 402, which, in turn, results in the noise propagation being suppressed within the boundaries of block 0 402. As block 0 402 is predicted using any mode other than the horizontal mode with the noise propagation suppressed therein, block 1 404 is predicted using the horizontal mode. Block 1 404 is also predicted through any mode other than the horizontal mode. However, if the horizontal mode offers the lowest residual, the horizontal mode is utilized for the prediction of block 1 404. To summarize, the horizontal mode is not suppressed during the prediction of block 1 404.

With the prediction of block 1 404, the first row of the 8×8 pixel blocks may end. Assuming the horizontal mode of prediction, block 2 406 is predicted based on pixels of a corresponding block of the left macroblock (e.g., A 204). Again, the possibility of noise propagation thereto due to the possible unavailability of the reconstructed pixels of the corresponding block of the left macroblock (e.g., A 204) and the use of the original pixels of the corresponding block instead necessitates suppression of the horizontal mode of prediction in block 2 406. Thus, the horizontal mode of prediction is suppressed in block 2 406, and any mode other than the horizontal mode is utilized for the prediction of block 2 406. In one or more embodiments, the noise propagation, therefore, is suppressed within the boundary between block 2 406 and block 3 408. Thus, for at least the same reason as with block 1 404, the horizontal mode is not suppressed during the prediction of block 3 408. It is obvious that although the horizontal mode is not suppressed in the prediction of block 3 408, any mode other than the horizontal mode is also utilized in the prediction.

FIG. 5 illustrates intra prediction of the current macroblock (e.g., macroblock 202) at the 4×4 pixel block level 500. The prediction block level (e.g., 4×4 pixel block level, 8×8 pixel block level) for the left macroblock (e.g., A 204) is checked for prior to making a decision with regard to the mode of prediction for blocks of the current macroblock (e.g., macroblock 202). When the intra prediction associated with the left macroblock (e.g., A 204) is at the 4×4 pixel block level or the 8×8 pixel block level and the variation in the intensity of pixels in the region including current macroblock (e.g., macroblock 202) continues, the intra prediction for the current macroblock (e.g., macroblock 202) is performed at the 4×4 pixel block level. As shown in FIG. 5, when the horizontal mode is used for intra prediction associated with blocks of the left macroblock (e.g., A 204), intra prediction at the 4×4 pixel block level for the current macroblock (e.g., macroblock 202) involves suppressing the horizontal mode in each of block 0 502, block 4 510, block 8 518 and block 12 526. Any mode other than the horizontal mode is utilized to predict block 0 502, block 4 510, block 8 518 and block 12 526 due to the possibility of utilizing reconstructed blocks.

The current macroblock (e.g., macroblock 202) includes sixteen 8×8 pixel blocks, viz., block 0 502, block 1 504, block 2 506, block 3 508, block 4 510, block 5 512, block 6 514, block 7 516, block 8 518, block 9 520, block 10 522, block 11 524, block 12 526, block 13 528, block 14 530 and block 15 532. Assuming the horizontal mode being used to predict blocks of the left macroblock (e.g., A 204), prediction of the 4×4 pixel blocks begins with block 0 502. As the availability of pixels of a corresponding reconstructed block of the immediately preceding left macroblock (e.g., A 204) is made difficult, the use of pixels of an original block of the left macroblock (e.g., A 204) instead of pixels of the reconstructed block may result in propagation of horizontal noise in block 0 502. Therefore, the horizontal mode is suppressed for block 0 502, which, in turn, results in the noise propagation being suppressed within the boundaries of block 0 502 (or, the boundary between block 0 502 and block 1 504). As block 0 502 is predicted using any mode other than the horizontal mode with the noise propagation suppressed, block 1 504 is predicted using the horizontal mode. As the noise propagation is suppressed within block 0 502, block 2 506 and block 3 508 is also predicted using the horizontal mode. It is noted that block 1 504, block 2 506 and block 3 508 are also predicted through any mode other than the horizontal mode. However, in one or more embodiments, if the horizontal mode offers the lowest residual, the horizontal mode is utilized for the prediction of block 1 504, block 2 506 and block 3 508. To summarize, the horizontal mode is not suppressed during the prediction of block 1 504, block 2 506 and block 3 508.

With the prediction of block 3 508, the first row of the 4×4 pixel blocks ends. Assuming the horizontal mode of prediction, block 4 510 is predicted based on pixels of a corresponding block of the left macroblock (e.g., A 204). Again, the possibility of noise propagation thereto due to the possible unavailability of the reconstructed pixels of the corresponding block of the left macroblock (e.g., A 204) and the use of the original pixels of the corresponding block instead necessitates suppression of the horizontal mode of prediction in block 4 510. Thus, the horizontal mode of prediction is suppressed in block 4 510, and any mode other than the horizontal mode is utilized for the prediction of block 4 510. The noise propagation, therefore, is suppressed within the boundary between block 4 510 and block 5 512. Thus, for at least the same reason as with block 1 504, the horizontal mode is not suppressed during the prediction of block 5 512. Although the horizontal mode is not suppressed in the prediction of block 5 512, any mode other than the horizontal mode may also be utilized in the prediction thereof.

Discussion with regard to prediction of block 6 514 and block 7 516 is analogous to the discussion associated with block 2 506 and block 3 508. Although any other mode other than the horizontal mode is utilized for the prediction of block 6 514 and block 7 516, the horizontal mode is not suppressed during the prediction thereof. Also, the horizontal mode is suppressed for block 8 518 and block 12 526 for reasons similar to those associated with block 0 502 and block 4 510. Although any other mode other than the horizontal mode may be utilized for the prediction of block 9 520, block 10 522, block 11 524, block 13 528, block 14 530 and block 15 532, the horizontal mode is not suppressed during the prediction.

To summarize, if the intra prediction of pixels of the immediate left macroblock (e.g., A 204) is at the 4×4 pixel block level or the 8×8 pixel block level and the intra prediction of pixels for the current macroblock (e.g., macroblock 202) is at the macroblock (e.g., 16×16 pixel block) level, then the horizontal mode may be suppressed for the entire current macroblock (e.g., macroblock 202). If the intra prediction for the current macroblock (e.g., macroblock 202) is at the 8×8 pixel block level or the 4×4 pixel block level, then the horizontal mode is suppressed for the first column of 8×8 pixel blocks or 4×4 pixel blocks constituting macroblock 202.

The horizontal mode has been shown with reference to FIGS. 3-5 merely as an example and that vertical modes (e.g., mode 0) is also suppressed during prediction at the macroblock (e.g., 16×16 pixel block) level, the 8×8 pixel block level and/or the 4×4 pixel block level. The vertical modes are suppressed for the first row of the 8×8 pixel blocks or the 4×4 pixel blocks constituting macroblock 202. Again, if the intra prediction of pixels for the current macroblock (e.g., macroblock 202) is at the macroblock (e.g., 16×16 pixel block) level, then the vertical mode is suppressed for the entire current macroblock (e.g., macroblock 202). In the case of the vertical mode of prediction, the propagation of “vertical” noise may be suppressed. Pixels of the top macroblock (e.g., B 206)/immediate top block are utilized in the intra prediction based on the vertical mode.

Further, the 16×16 pixel block, the 8×8 pixel block and the 4×4 pixel block are merely shown for purposes of illustration. Current and future video standards including different macroblock sizes are within the scope of the exemplary embodiments. For example, the macroblock is an N×N pixel block (where N is an even, positive integer) and horizontal/vertical modes are suppressed during prediction of blocks at the macroblock level and the sub-macroblock level (e.g., (N/2)×(N/2) block level, (N/4)×(N/4) block level, (N/8)×(N/8) block level). In another example, the macroblock is an M×N pixel block (where M and N both are even, positive integers), where prediction is performed at both the macroblock level and the sub-macroblock level (e.g., (M/2)×(N/2) block level, (M/4)×(N/4) block level, (M/4)×(N/8) block level, (M/8)×(N/4) block level).

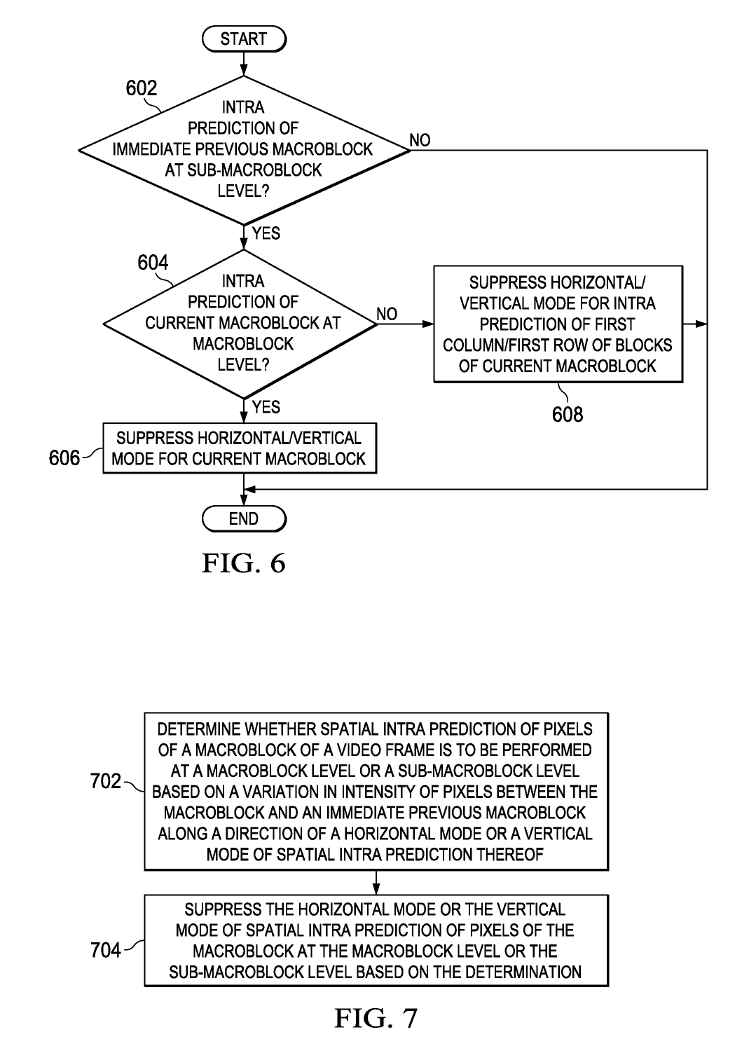

FIG. 6 illustrates a flowchart detailing the operations involved in intra prediction at the macroblock and the sub-macroblock level, according to one or more embodiments. Operation 602 involves checking as to whether intra prediction for pixels of the immediately preceding macroblock (e.g., immediate left macroblock A 204, immediate top macroblock B 206) in the direction of the horizontal/vertical mode of prediction is at the sub-macroblock level. For example, intra prediction for pixels of the immediate left macroblock may be at the 4×4 pixel block level or 8×8 pixel block level. If the result of operation 602 is a yes, then operation 604 involves checking as to whether intra prediction of the current macroblock (e.g., macroblock 202) is at the macroblock (e.g., 16×16 pixel block) level. If yes, operation 606 then involves suppressing the corresponding horizontal/vertical mode of prediction for the current macroblock (e.g., macroblock 202). If no, operation 608 involves suppressing the appropriate horizontal/vertical mode of prediction for the corresponding first column/first row of blocks (e.g., 4×4 pixel block, 8×8 pixel block) constituting the current macroblock (e.g., macroblock 202). Intra prediction of a constituent block constitutes intra prediction at the sub-macroblock level.

When the prediction for the immediate previous macroblock is at the macroblock level, the horizontal/vertical modes does not need to be suppressed for blocks of the current macroblock (e.g., macroblock 202)/current macroblock (e.g., macroblock 202) because of the lower probability of noise propagation from a region having little variations in intensity of pixels therein.

As discussed above, the horizontal/vertical mode is suppressed during prediction associated with video encoder 100. Video encoder 100 is associated with an encoding engine included in a camera (e.g., a digital camera). In one or more embodiments, the camera is associated with a data/video processing system (e.g., a tablet, a laptop, a desktop, a server, a mobile phone). The horizontal/vertical mode is suppressed during prediction associated with a video transcoder (e.g., part of a mobile phone) configured to convert a video input thereto from one format (e.g., MPEG-4) to another format (e.g., audio video interleave (AVI)). The aforementioned video encoding service or the video transcoding service is available as a remote service/cloud service. For example, an AVI file of a video recorded using a still camera is uploaded to a video sharing website, which may decode the file into a standard format through an appropriate cloud service. The video is, again, encoded into a desired format (e.g., H.264, On2®'s VP7™, Google®'s VP8™) suitable to the video sharing website.

A transcoder may also include another decoder configured to decode a compressed bit stream and encoder configured to encode the output of another decoder. The transcoder is provided in a video processing system including the decoder associated with decoding the output of the transcoder. The horizontal/vertical mode suppression is valid for still image files also because of the I-frames employed. The exemplary embodiments have been discussed with regard to an H.264 video standard merely as an example. Other video standards such as On2®'s VP7™and Google®'s VP8™ are within the scope of the exemplary embodiments.

Also, intra prediction estimation module 130 of video encoder 100 is associated with a processor (e.g., a Central Processing Unit (CPU), a co-processor) configured to perform the operations described above. Instructions associated with the intra prediction are stored in a Read-Only Memory (ROM) or an instruction memory associated with the processor. In a hardware implementation, the decision making associated with the choice of prediction modes for blocks of macroblock 202 is associated with logic circuits (e.g., logic gates).

FIG. 7 illustrates a process flow diagram detailing the operations involved in a method of improved spatial intra prediction. Operation 702 involves determining whether spatial intra prediction of pixels of a macroblock (e.g., macroblock 202) of a video frame (e.g., input frame 102) is to be performed at a macroblock level or a sub-macroblock level based on a variation in intensity of pixels between the macroblock and an immediate previous macroblock along a direction of a horizontal mode or a vertical mode of spatial intra prediction. The macroblock is configured to be an array of pixels, the horizontal mode of spatial intra prediction is configured to be along a direction of a row of the array of pixels at the macroblock level and the sub-macroblock level, and the vertical mode of spatial intra prediction is configured to be along a direction of a column of the array of pixels at the macroblock level and the sub-macroblock level.

Operation 704 involves suppressing, when spatial intra prediction of pixels of the immediate previous macroblock is at the sub-macroblock level, the horizontal mode or the vertical mode of spatial intra prediction of pixels of the macroblock at the macroblock level or the sub-macroblock level based on the determination. When the spatial intra prediction of the pixels of the macroblock is at the macroblock level, the horizontal mode or the vertical mode is suppressed for the entire macroblock. When the spatial intra prediction of the pixels of the macroblock is at the sub-macroblock level, the horizontal mode or the vertical mode is suppressed for a corresponding first column or a first row of blocks of pixels of the macroblock. The macroblock is configured to include an array of blocks of pixels at the sub-macroblock level.

Although the present embodiments have been described with reference to specific example embodiments, it will be evident that various modifications and changes may be made to these embodiments without departing from the broader spirit and scope of the invention. For example, the various systems, devices, apparatuses, and circuits, etc. described herein may be enabled and operated using hardware circuitry, firmware, software or any combination of hardware, firmware, or software embodied in a machine readable medium. The various electrical structures and methods may be embodied using transistors, logic gates, application specific integrated (ASIC) circuitry or Digital Signal Processor (DSP) circuitry.

In addition, it will be appreciated that the various operations, processes, and methods disclosed herein may be embodied in a machine-readable medium or a machine accessible medium compatible with a data processing system, and may be performed in any order. Accordingly, the specification and drawings are to be regarded in an illustrative rather than a restrictive sense.

What is claimed is:

1. A method comprising:
determining whether spatial intra prediction of pixels of a macroblock of a video frame is to be performed at one of a macroblock level and a sub-macroblock level based on a variation in intensity of pixels between the macroblock and an immediate previous macroblock along a direction of one of a horizontal mode and a vertical mode of spatial intra prediction; and
suppressing, when spatial intra prediction of pixels of the immediate previous macroblock is at the sub-macroblock level, the one of the horizontal mode and the vertical mode of spatial intra prediction of pixels of the macroblock at the one of the macroblock level and the sub-macroblock level based on the determination such that:
when the spatial intra prediction of the pixels of the macroblock is at the macroblock level, the one of the horizontal mode and the vertical mode is suppressed for the entire macroblock, and
when the spatial intra prediction of the pixels of the macroblock is at the sub-macroblock level, the one of the horizontal mode and the vertical mode is suppressed for a corresponding one of a first column and a first row of blocks of pixels of the macroblock, the macroblock being configured to include an array of blocks of pixels at the sub-macroblock level.

2. The method of claim 1 further comprising performing spatial intra prediction of pixels of the macroblock through:
a corresponding one of a non-horizontal mode and a non-vertical mode at the macroblock level for the entire macroblock, and
the corresponding one of the non-horizontal mode and the non-vertical mode at the sub-macroblock level for the corresponding one of the first column and the first row of blocks of pixels of the macroblock.

3. The method of claim 1, wherein the video frame is one of an Intra- (I-) frame, a Predictive- (P-) frame, and a Bi-predictive (B-) frame.

4. The method of claim 1,
wherein the macroblock is an M×N array of pixels, and
wherein M and N are positive integers.

5. The method of claim 2, further comprising performing, at the sub-macroblock level, spatial intra prediction of other blocks of pixels of the macroblock through one of the corresponding one of the horizontal mode and the vertical mode and the corresponding one of the non-horizontal mode and the non-vertical mode.

6. The method of claim 2, further comprising performing, at the sub-macroblock level, spatial intra prediction of other blocks of pixels of the macroblock through one of the corresponding one of the horizontal mode and the vertical mode and the corresponding one of the non-horizontal mode and the non-vertical mode.

7. A video encoder comprising:
an intra prediction estimation module configured to receive a video frame and to:
determine whether spatial intra prediction of pixels of a macroblock of the video frame is to be performed at one of a macroblock level and a sub-macroblock level based on a variation in intensity of pixels between the macroblock and an immediate previous macroblock along a direction of one of a horizontal mode and a vertical mode of spatial intra prediction thereof,
suppress, when spatial intra prediction of pixels of the immediate previous macroblock is at the sub-macroblock level, the one of the horizontal mode and the vertical mode of spatial intra prediction of pixels of the macroblock at the one of the macroblock level and the sub-macroblock level based on the determination such that:
when the spatial intra prediction of the pixels of the macroblock is at the macroblock level, the one of the horizontal mode and the vertical mode is suppressed for the entire macroblock, and
when the spatial intra prediction of the pixels of the macroblock is at the sub-macroblock level, the one of the horizontal mode and the vertical mode is suppressed for a corresponding one of a first column and a first row of blocks of pixels of the macroblock, the macroblock being configured to include an array of blocks of pixels at the sub-macroblock level,
perform spatial intra prediction of the pixels of the macroblock of the video frame based on the determination and the suppression, and
output a prediction macroblock;
a subtractor module configured to receive the prediction macroblock from the intra prediction estimation module and the macroblock of the video frame and to output the difference therebetween as a residual macroblock;
a transform and quantization module configured to transform the residual macroblock to a different domain and to quantize the output of the transformation; and
a coding module configured to code the output of the transform and quantization module.

8. The video encoder of claim 7, wherein the video frame is one of an Intra- (I-) frame, a Predictive- (P-) frame , and a Bi-predictive (B-) frame.

9. The video encoder of claim 7, wherein the intra prediction estimation module is configured to perform the spatial intra prediction of pixels of the macroblock through:
a corresponding one of a non-horizontal mode and a non-vertical mode at the macroblock level for the entire macroblock, and
the corresponding one of the non-horizontal mode and the non-vertical mode at the sub-macroblock level for the corresponding one of the first row and the first column of blocks of pixels of the macroblock.

10. The video encoder of claim 7,
wherein the macroblock is an M×N array of pixels, and
wherein M and N are positive integers.

11. The video encoder of claim 9,
wherein the output of the coding module is a bit stream configured to include information required to decode the macroblock of the video frame, and
wherein the information required to decode the macroblock includes the mode of intra prediction performed by the intra prediction estimation module.

12. The video encoder of claim 9, wherein, at the sub-macroblock level, the intra prediction estimation module is configured to perform spatial intra prediction of other blocks of pixels of the macroblock through one of the corresponding one of the horizontal mode and the vertical mode and the corresponding one of the non-horizontal mode and the non-vertical mode.

13. A video processing system comprising:
a video encoder configured to encode a video frame input thereto, the video encoder comprising:
an intra prediction estimation module configured to:
determine whether spatial intra prediction of pixels of a macroblock of the video frame is to be performed at one of a macroblock level and a sub-macroblock level based on a variation in intensity of pixels between the macroblock and an immediate previous macroblock along a direction of one of a horizontal mode and a vertical mode of spatial intra prediction thereof,
suppress, when spatial intra prediction of pixels of the immediate previous macroblock is at the sub-macroblock level, one of the horizontal mode and the vertical mode of spatial intra prediction of pixels of the macroblock at the one of the macroblock level and the sub-macroblock level based on the determination such that:
when the spatial intra prediction of the pixels of the macroblock is at the macroblock level, the one of the horizontal mode and the vertical mode is suppressed for the entire macroblock, and
when the spatial intra prediction of the pixels of the macroblock is at the sub-macroblock level, the one of the horizontal mode and the vertical mode is suppressed for a corresponding one of a first column and a first row of blocks of pixels of the macroblock, the macroblock being configured to include an array of blocks of pixels at the sub-macroblock level,
perform spatial intra prediction of the pixels of the macroblock of the video frame based on the determination and the suppression, and
output a prediction macroblock;
a subtractor module configured to receive the prediction macroblock from the intra prediction estimation module and the macroblock of the video frame and to output the difference therebetween as a residual macroblock;
a transform and quantization module configured to transform the residual macroblock to a different domain and to quantize the output of the transformation; and
a coding module configured to code the output of the transform and quantization module in a compressed bit stream; and
a video decoder configured to receive the compressed bit stream from the video encoder and to decode the macroblock of the video frame.

14. The video processing system of claim 13, wherein the video frame is one of an Intra- (I-) frame, a Predictive- (P-) frame and a Bi-predictive (B-) frame.

15. The video processing system of claim 13, wherein the intra prediction estimation module is configured to perform spatial intra prediction of pixels of the macroblock through:
a corresponding one of a non-horizontal mode and a non-vertical mode at the macroblock level for the entire macroblock, and
the corresponding one of the non-horizontal mode and the non-vertical mode at the sub-macroblock level for the corresponding one of the first row and the first column of blocks of pixels of the macroblock.

16. The video processing system of claim 13,
wherein the macroblock is an M×N array of pixels, and
wherein M and N are positive integers.

17. The video processing system of claim 13, further comprising:
a video source configured to generate the video frame; and
a display unit configured to be one of associated with the video source and distinct from the video source and to render the video frame following decoding of constituent macroblocks thereof through the video decoder.

18. The video processing system of claim 13, wherein encoding through the video encoder is provided as part of a remote service.

19. The video processing system of claim 13, further comprising another video decoder configured to generate the video frame configured to be input to the video encoder, wherein the another video decoder and the encoder are configured to serve as a transcoder, the transcoder being configured to convert a video frame from one format to a format associated with the video frame configured to be input to the video encoder.

20. The video processing system of claim 13, wherein the video processing system is associated with one of a computing system and a mobile phone.

21. The video processing system of claim 15, wherein, at the sub-macroblock level, the intra prediction estimation module is configured to perform spatial intra prediction of other blocks of pixels of the macroblock through one of the corresponding one of the horizontal mode and the vertical mode and the corresponding one of the non-horizontal mode and the non-vertical mode.

22. The method of claim 1, wherein the macroblock is configured to be an array of pixels, the horizontal mode of spatial intra prediction is configured to be along a direction of a row of the array of pixels at the macroblock level and the sub-macroblock level, and the vertical mode of spatial intra prediction is configured to be along a direction of a column of the array of pixels at the macroblock level and the sub-macroblock level.

23. The video encoder of claim 7, wherein the macroblock is configured to be an array of pixels, the horizontal mode of spatial intra prediction is configured to be along a direction of a row of the array of pixels at the macroblock level and the sub-macroblock level, and the vertical mode of spatial intra prediction is configured to be along a direction of a column of the array of pixels at the macroblock level and the sub-macroblock level,

24. The video processing system of claim 13, wherein the macroblock is configured to be an array of pixels, the horizontal mode of spatial intra prediction is configured to be along a direction of a row of the array of pixels at the macroblock level and the sub-macroblock level, and the vertical mode of spatial intra prediction is configured to be along a direction of a column of the array of pixels at the macroblock level and the sub-macroblock level,
